(19) United States
(12) Patent Application Publication
(10) Pub. No.: US 2023/0135585 A1
(43) Pub. Date: May 4, 2023

(54) RADAR DEVICE AND RADAR METHOD

(71) Applicant: Robert Bosch GmbH, Stuttgart (DE)

(72) Inventors: Benedikt Loesch, Stuttgart (DE); Arthur Hipke, Leonberg (DE); Michael Schoor, Stuttgart (DE)

(21) Appl. No.: 18/051,669

(22) Filed: Nov. 1, 2022

(30) Foreign Application Priority Data
Nov. 3, 2021 (DE) 10 2021 212 393.7

(51) Int. Cl. G01S 13/42; G01S 13/48

(52) U.S. Cl. CPC G01S 13/424; G01S 13/48; G01S 2013/462

(57) ABSTRACT

A radar device. The radar device includes a transceiver unit that includes at least three transmitting antennas and at least three receiving antennas, the transceiver unit being designed to emit radar radiation with the aid of the transmitting antennas, to receive radar radiation with the aid of the receiving antennas, and to generate radar data based on the received radar radiation. The radar device further includes an evaluation unit, which is configured to estimate, by evaluating the radar data, at least one angle of at least one target using a 2-target angle estimation model, the 2-target angle estimation model taking the propagation of the radar radiation along four paths into account.

### CROSS REFERENCE

The present application claims the benefit under 35 U.S.C. § 119 of German Patent Application No. DE 10 2021 212 393.7 filed on Nov. 3, 2021, which is expressly incorporated herein by reference in its entirety.

### FIELD

The present invention relates to a radar device and to a radar method.

### BACKGROUND INFORMATION

For surroundings monitoring in driver assistance systems, the azimuth angle and elevation angle, in addition to the distance and to the relative velocity, are of major importance, since in this way, a lane assignment may be carried out and a determination may be made about the relevance of the target. Thus, it may be ascertained whether an object may be driven over, may be driven against or may be driven under.

Azimuth and elevation angles of the targets may be ascertained from amplitudes and/or from phase differences of transceiver antennas of an antenna array. In order to improve the accuracy and separability of the angle estimation, the MIMO principle (multiple input multiple output) may be used. In contrast to classical SIMO radars (single input multiple output) including one transmitting antenna and multiple receiving antennas, multiple transmitting antennas and multiple receiving antennas are used for this purpose.

In the angle estimation, the received signals are compared with a previously measured angle-dependent antenna diagram. In the event that only one target is located in a (d,v) cell, d referring to the distance and v to the relative velocity, the estimated angle results as the position of the best match between the received signal and the antenna diagram.

A MIMO radar sensor is described in U.S. Pat. No. 8,436,763 B2, which uses the MIMO principle including code multiplex and two transmitting antennas in order to improve the azimuth angle estimation. In this case, the two transmitting antennas are situated at the left and the right edge of the entire array in order in this way to achieve a preferably large virtual aperture.

In the case of multipath propagation, four paths occur, namely a direct path or a reflected first path section when emitting combined with a direct or reflected second path section when receiving.

For this reason, the advantages of MIMO, for example, an enlarged virtual aperture and an improved angle separation, are unable to be utilized during multipath propagation using only two transmitting antennas. In Engels et al., “Automotive MIMO radar angle estimation in the presence of multipath,” European Radar Conference (EURAD), 2017, pp. 82-85, it is described, for example, that a fallback to a SIMO performance occurs when taking the multipath propagation in the signal model into account. The result is a non-coherent averaging of the SIMO angle spectra of the two transmitting antennas.

By ignoring the multipath propagation in the signal model, a MIMO angle estimation provides false estimated values including errors of multiple degrees. This may then result in undesirable system behavior, for example, adjacent lane disruptions or target object losses.

Multipath propagation also means that in the case of MIMO beam forming, i.e., transmitting and receiving beam forming, the virtual array model may not be utilized. Engels et al., “Automotive Radars Signal Processing: Research Directions and Practical Challenges,” in IEEE Journal of Selected Topics in Signal Processing, 2021, describe as a remedial measure a beam forming that includes separate grids for the transmitting angle and the receiving angle. However, this method is unable to be used for high-resolution angle estimation, since in this case, the four paths are not considered in a shared signal model.

### SUMMARY

The present invention provides a radar device and a radar method.

Advantageous refinements are the present invention are disclosed herein.

According to one first aspect, the present invention relates to a radar device including a transceiver unit that includes at least three transmitting antennas and at least three receiving antennas, the transceiver unit being designed to emit radar radiation with the aid of the transmitting antennas, to receive radar radiation with the aid of the receiving antennas and to generate radar data based on the received radar radiation. According to an example embodiment of the present invention, the radar device further includes an evaluation unit, which is designed to estimate, by evaluating the radar data, at least one angle of at least one target using a 2-target angle estimation model, the 2-target angle estimation model taking the propagation of radar radiation along four paths into account.

According to one second aspect, the present invention relates to a radar method. The radar method includes the emitting and receiving of radar radiation with the aid of a transceiver unit that includes at least three transmitting antennas and at least three receiving antennas, and the generation of radar data based on the received radar data. According to an example embodiment of the present invention, the method further includes the evaluation of the radar data using a 2-target angle estimation model in order to estimate at least one angle of at least one target, the 2-target angle estimation taking the propagation of radar radiation along four paths into account.

The present invention allows for the robust and unambiguous angle estimation also during multipath propagation. By correctly taking the four propagation paths into account, it is possible to avoid angle errors. The azimuth estimation is possible by using at least three transmitting antennas and at least three receiving antennas. For a reflection at a surface, the two targets of the 2-target angle estimation model include the actual target and a mirror object.

With at least three transmitting antennas and three receiving antennas, it is further possible to maintain the performance gain via MIMO and no fallback to the SIMO or MISO performance occurs.

When using offset transmitting antennas and receiving antennas, it is also possible to estimate the elevation angle.

According to one further specific example embodiment of the radar device according to the present invention, the four paths include a direct path, a reflection path, and two cross paths, each of the four paths including a first path section from the transmitting antennas to the target and a second path section from the target to the receiving antennas, in the case of the direct path, the propagation of the radar radiation on the first path section and on the second path section taking place directly in each case, in the case of the reflection path, the propagation of the radar radiation on the first path section and on the second path section taking place via a reflection in each case, in the case of a first of the cross paths, the propagation of the radar radiation on the first path section taking place directly and on the second path section via a reflection, and in the case of a second of the cross paths, the propagation of the radar radiation on the second path section taking place directly and on the second path section via a reflection.

According to one further specific example embodiment of the radar device of the present invention, the transmitting antennas and the receiving antennas are situated in areas spatially separated from one another. Thus, in the installed state of the radar sensor, the transmitting antennas may be situated above or below the receiving antennas. For example, the transceiver unit includes a circuit board, the transmitting antennas being situated in a first half of the circuit board, and the receiving antennas being situated in a second half of the circuit board. The transmitting antennas may, for example, be situated above or below the receiving antennas, since this then allows for small spaces between the phase centers and, at the same time, the radar device remains compact in the horizontal direction. With such an arrangement, it is possible to implement horizontally overlapping antennas, which would not be possible without a vertical offset between transmitting antennas and receiving antennas, or only possible by situating the transmitting array horizontally adjacent to the receiving array, which would result in the radar device being larger in size in the horizontal direction.

According to one further specific example embodiment of the radar device of the present invention, the evaluation unit is situated between the transmitting antennas and the receiving antennas. In this way, the leads to the transmitting antennas and receiving antennas may be kept short.

According to one further specific example embodiment of the radar device of the present invention, at least three transmitting antennas are situated horizontally next to one another and at least three receiving antennas are situated horizontally next to one another. At least one further transmitting antenna is further situated vertically offset to the three transmitting antennas and/or at least one further receiving antennas is situated vertically offset to the at least three receiving antennas. The evaluation unit is designed to estimate an elevation angle and an azimuth angle from the at least one target.

According to one further specific example embodiment of the radar device of the present invention, it is possible in the elevation direction to forgo the MIMO principle, i.e., the elevation angle estimation may be carried out merely using one or multiple vertically offset transmitting antennas (MISO) or using one or multiple vertically offset receiving antennas (SIMO). Thus, in this case, all transmitting antennas are situated horizontally next to one another and the at least one further receiving antenna is vertically offset to the at least three receiving antennas situated horizontally next to one another, or alternatively, all receiving antennas are situated horizontally next to one another and the at least one further transmitting antenna is situated vertically offset to the at least three transmitting antennas situated horizontally next to one another.

According to one further specific example embodiment of the present invention, for radar devices that include a limited number of transmitting and receiving channels (for example, four transmitting antennas and four receiving antennas) and limited separability in the elevation direction, it is still possible to use the MIMO principle in the elevation direction with fewer than three transmitting antennas and three receiving antennas. The evaluation unit is thus designed to estimate an elevation angle using a MIMO method using fewer than three transmitting antennas and fewer than three receiving antennas. The degree of impairment of a MIMO elevation estimation without a 4-path model is a function of the degree of the strength of the cross paths and thus of the reflection factor, for example, of the road or of a roof in the tunnel, as well as of the bi-static (angle of incidence does not equal angle of reflection) reflection properties of the observed object. In general, the reflected output decreases more strongly the greater the difference is between the angle of incidence and the angle of reflection.

According to one further specific example embodiment of the radar device of the present invention, at least one transmitting antenna exhibits a horizontal overlap with at least one receiving antenna. This allows for a compact design.

According to one further specific example embodiment of the radar device of the present invention, the evaluation unit is designed to estimate the at least one angle of the at least one target using a maximum likelihood estimation.

According to one further specific example embodiment of the radar device of the present invention, the evaluation unit is designed to initially estimate at least one first angle estimated value of the at least one target using a first angle grid and to subsequently estimate at least one second angle estimated value of the at least one target by the at least first angle estimated value using a second angle grid, the second angle grid being finer than the first angle grid. In this way, it is possible in a two-step method to achieve a high degree of accuracy.

Further advantages, features and details of the present invention result from the following description, in which different exemplary embodiments are described in detail with reference to the figures.

### BRIEF DESCRIPTION OF THE DRAWINGS

FIG. 1 shows a block diagram of a radar device according to one specific example embodiment of the present invention.

FIG. 2 shows an exemplary situation including a real target and a mirror object.

FIG. 3 shows an exemplary situation including two real targets.

FIG. 4 shows a top view of a radar device according to one specific example embodiment of the present invention.

FIG. 5 shows a top view of a radar device according to one further specific example embodiment of the present invention.

FIG. 6 shows a top view of a radar device according to one further specific example embodiment of the present invention.

FIG. 7 shows a flowchart of a radar method according to one specific example embodiment of the present invention.

In all figures, identical or functionally identical elements and devices are provided with the same reference numerals. The numbering of method steps is used for the sake of clarity and in general is not intended to imply any particular chronological sequence. Multiple method steps may, in particular, also be carried out simultaneously.

### DETAILED DESCRIPTION OF EXAMPLE EMBODIMENTS

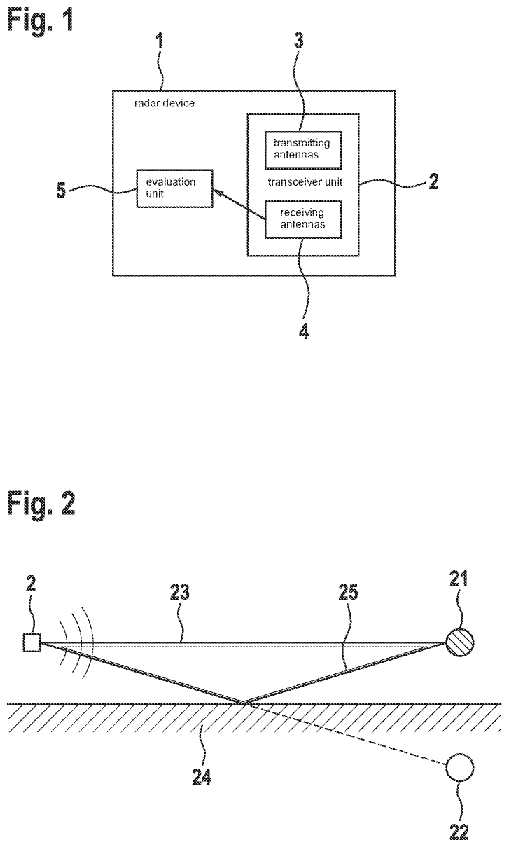

FIG. 1 shows a block diagram of a radar device 1 including a transceiver unit 2 that includes at least three transmitting antennas 3 and at least three receiving antennas 4.

Transceiver unit 2 emits radar radiation with the aid of transmitting antennas 3. Receiving antennas 4 receive the radar radiation and transceiver unit 2 generates radar data based on the received radar radiation.

The radar data are transferred to an evaluation unit 5. Evaluation unit 5 may include a microprocessor, a microcontroller or the like.

Evaluation unit 5 evaluates the radar data. The evaluation takes place using a 1-target angle estimation model, one first 2-target angle estimation model, which takes the propagation of radar radiation along two paths into account, and one second 2-target angle estimation model, which takes the propagation of radar radiation along four paths into account.

Using the angle estimation model, evaluation unit 5 ascertains an azimuth angle of a target. Optionally, an elevation angle of the target may also be ascertained.

FIG. 2 shows an exemplary situation including a real target 21 and a mirror object 22. The propagation of the radar radiation between transceiver unit 2 and target 21 may take place via four paths. The four paths in this case include a direct path, a reflection path and two cross paths. The four paths each include a first path section from transmitting antennas 3 of transceiver unit 2 to target 21 and a second path section from target 21 to receiving antennas 4 of transceiver unit 2.

In the case of the direct path, the propagation of the radar radiation on the first path section and on the second path section takes place directly in each case, i.e., via a first propagation path 23. In the case of the reflection path, the propagation of the radar radiation on the first path section and on the second path section takes place in each case via a reflection at an extended object 24, i.e., along a second propagation path 25. In the case of a first of the cross paths, the propagation of the radar radiation on the first path section takes place directly (via first propagation path 23) and on the second path section via a reflection (via second propagation path 25). In the case of the second of the cross paths, the opposite occurs, i.e., the propagation of the radar radiation takes place directly on the second path section (via first propagation path 23) and on the first path section via a reflection (via second propagation path 25).

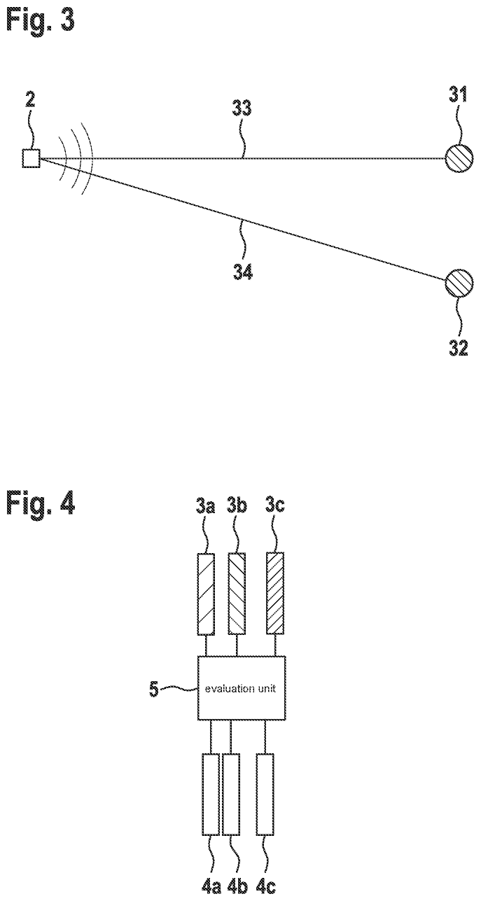

FIG. 3 shows one exemplary situation including two real targets 31, 32. The radar radiation in this case propagates both on the first path section from transceiver unit 2 to respective target 31, 32 as well as on the second path section from respective target 31, 32 to transceiver unit 2 on direct path 33, 34.

The first 2-target angle estimation model takes only the propagation of radar radiation along two paths into account, i.e., on the direct path between transceiver unit 2 and target 21, 31, 32. An angle estimation based on the first 2-target angle estimation model will thus exhibit a high quality in the situation shown in FIG. 3, but only a low quality in the situation shown in FIG. 2, since the cross paths are not taken into account, i.e., larger angle errors occur.

The second 2-target angle estimation model takes the propagation of radar radiation along four paths into account and, as a result, an angle estimation based on the second 2-target angle estimation model may exhibit a high quality both for the situation in FIG. 2 as well as for the situation in FIG. 3.

The 1-target angle estimation model and the first and second 2-target angle estimation models are described in greater detail below.

The 1-target angle estimation model may be a virtual array model. For received signal x for all combinations of transmitters (TX) and receivers (RX) it is the case in this model that

x=a(θ)·sn

a(θ) referring to the control vector, which indicates the phase relations of the transmitter and the receiver, s referring to a complex channel coefficient, n being a noise contribution, and θ indicating the angle of the target. This angle may be the azimuth angle. According to further specific embodiments, both the azimuth angle as well as the elevation angle may be ascertained.

Furthermore, the control vector may be written as the Kronecker product of the contributions of the individual sensors and receivers:

$$\underline{a} ( θ ) = {\underline{a}}_{tx} ( θ ) ⊗ {\underline{a}}_{rx} ( θ ) or \\ \underline{a} ( θ ) = {\underline{\tilde{a}}}_{tx} ( θ ) ⊗ {\underline{\tilde{a}}}_{rx} ( θ ) where : {\underline{\tilde{a}}}_{tx} ( θ ) = {[ \frac{{a}_{tx , n} ( θ )}{{a}_{tx , 1} ( θ )} ]}_{n = 1 , … , {N}_{tx}} , \\ {\underline{\tilde{a}}}_{rx} ( θ ) = {a}_{tx , 1} ( θ ) \cdot {\underline{a}}_{rx} ( θ )$$

Nₜₓ referring to the number of transmitters. Thus, for three transmitters and three receivers, a has nine entries.

The first 2-target angle estimation model taking two paths into account ascertains received signal x as follows:

x=A·s+n

θ₁ and θ₂ describing the angle of the two targets. It is further the case that:

A(θ₁,θ₂)=[ãₜₓ(θ₁)⊗ãᵣₓ(θ₁)ãₜₓ(θ₂)⊗ãᵣₓ(θ₂)]

thus, only two paths are taken into account, in which the angles for the transmitter and the receiver are each identical.

The second 2-target angle estimation model (cross path model) taking four paths into account ascertains received signal x as follows:

A(θ₁,θ₂)=[ãₜₓ(θ₁)⊗ãᵣₓ(θ₁)ãₜₓ(θ₂)⊗ãᵣₓ(θ₂)ãₜₓ(θ₂)⊗ãᵣₓ(θ₁)ãₜₓ(θ₁)⊗ãᵣₓ(θ₂)]

The two cross paths correspond to the last two entries, the angles for transmitter and receiver each being different.

Due to the reciprocity,

ãₜₓ(θ₂)⊗ãᵣₓ(θ₁)

and

ãₜₓ(θ₁)⊗ãᵣₓ(θ₂)

may be combined to form one path:

A(θ₁,θ₂)[ãₜₓ(θ₁)⊗ãᵣₓ(θ₁)ãₜₓ(θ₂)⊗ãᵣₓ(θ₂)ãₜₓ(θ₂)⊗ãᵣₓ(θ₁)ãₜₓ(θ₁)⊗ãᵣₓ(θ₂)]

The evaluation unit uses a deterministic maximum likelihood (DML) function, which reads as follows:

q²(θ₁,θ₂)=x^{H}·P_{A}(θ₁,θ₂)·x,P_{A}(θ₁,θ₂)=A(A^{H}A)⁻¹A^{H}

P_{A} referring to the projection matrix on the column space of matrix A.

Angles θ₁ and θ₂ are calculated by evaluation unit 5 by maximizing

q²(θ₁,θ₂)

For the cross path model, it is the case that for Nₜₓ=2 of two transmitting units, the MIMO estimation is downgraded to a non-coherent summation of the SIMO (single in multiple out) spectra. In the case of Nᵣₓ=2 of two receiving units, the MIMO estimation is further downgraded to a non-coherent summation of the MISO (multiple in single out) spectra. Thus, according to the present invention, at least three transmitting antennas 3 and at least three receiving antennas 4 are provided.

The calculation of the DML function q²(θ₁, θ₂) may be simplified with the aid of the compact or economical singular value decomposition (SVD) of matrix A as follows:

A=U·S·V^{H}

P_{A}(θ₁,θ₂)=USV^{H}(VSU^{H}USV^{H})⁻¹VSU^{H}=UU^{H}

q²(θ₁,θ₂)=x^{H}UU^{H}x=|U^{H}x|²

In this case, matrix U is a complex orthonormal matrix including dimensions (NₜₓNᵣₓ)×4, matrix S is a (NₜₓNᵣₓ)×4 matrix including non-negative entries on the diagonal and matrix V is a complex orthonormal matrix including dimensions 4×4.

Matrix U is a function only of the antenna diagram and may be calculated once in advance for all angles θ₁ and θ₂, so that the calculation of the cost function for each target and for each angle pair (θ₁, θ₂) is made up of the 4 scalar products U^{H}x.

The memory space required for calculated matrices U may be reduced with the aid of the decomposition

A=Aₜₓ(θ₁,θ₂)⊗Aᵣₓ(θ₁,θ₂)

Aₜₓ(θ₁,θ₂)=[aₜₓ(θ₁)aₜₓ(θ₂)]

Aᵣₓ(θ₁,θ₂)=[aᵣₓ(θ₁)aᵣₓ(θ₂)]

and of the SVD of matrices Aₜₓ (θ₁, θ₂) and Aᵣₓ (θ₁, θ₂) as follows:

A=Aₜₓ(θ₁,θ₂)⊗Aᵣₓ(θ₁,θ₂)=UₜₓSₜₓVₜₓ^{H}⊗UᵣₓSᵣₓVᵣₓ^{H}

U=Uₜₓ⊗Uᵣₓ

q²(θ₁,θ₂)=|(Uₜₓ⊗Uᵣₓ)^{H}x|²=∥Uₜₓ^{H}XUᵣₓ^{x}∥_{F}²

The dimensionality of matrices Uₜₓ and Uᵣₓ is Nₜₓ×2 and Nᵣₓ×2, respectively. With this representation, therefore, instead of 4NₜₓNᵣₓ, only 2Nₜₓ+2Nᵣₓ entries overall are required. In the final step of the equation, the received signals for all transmitting antennas are no longer represented as vector x with length NₜₓNᵣₓ, but as matrix X with dimensions Nₜₓ×Nᵣₓ. Here, ∥·∥_{F}² refers to the Frobenius norm of a matrix, i.e., to the sum of the square values of all entries.

Alternatively, the calculation of the DML function q²(θ₁, θ₂) may also be simplified with the aid of the decomposition A=Aₜₓ(θ₁, θ₂) Aᵣₓ(θ₁, θ₂) and the calculation rules for Kronecker products to become

q²(θ₁,θ₂)=vec(Y)^{H}·vec(G_{rX}YGₜₓ)=vec(Y)^{H}·(Gₜₓ^{T}⊗Gᵣₓ)·vec(Y)

where

Y=Aᵣₓ^{H}·X·Aₜₓ*and Gᵣₓ=(Aᵣₓ^{H}Aᵣₓ)⁻¹and Gₜₓ=(Aₜₓ^{H}Aₜₓ)⁻¹

Operator vec(Y) in this case orders the elements of matrix Y with the dimension 2×2 as vectors with a length of 4. The 2×2 matrices Gᵣₓ and Gₜₓ are a function only of antenna diagram ab and may be determined once in advance for each angle pair (θ₁, θ₂). By normalizing columns Aₜₓ and Aᵣₓ to form vector norm 1, it is possible to store matrices Gᵣₓ and Gₜₓ, in each case with the aid of only one complex parameter β:

$${G}_{rx} = \frac{1}{1 - {\vert {β}_{rx} \vert}^{2}} [ \begin{matrix}1 & - {β}_{rx} \\ - {β}_{rx}^{*} & 1\end{matrix} ] or {G}_{tx} = \frac{1}{1 - {\vert {β}_{tx} \vert}^{2}} [ \begin{matrix}1 & - {β}_{tx} \\ - {β}_{tx}^{*} & 1\end{matrix} ]$$

Optionally, the real scaling factor

$$\frac{1}{1 - {\vert β \vert}^{2}}$$

may also be stored in each case in order to further reduce the computing effort.

To further reduce the runtime, evaluation unit 5 may initially carry out a rough search via a first angle grid (θ₁, θ₂) of, for example, a grid width between 1° and 2°. Evaluation unit 5 subsequently carries out a fine search using a finer second angle grid, for example, with a grid width between 0.1° and 0.2° around the maximum determined in the rough search.

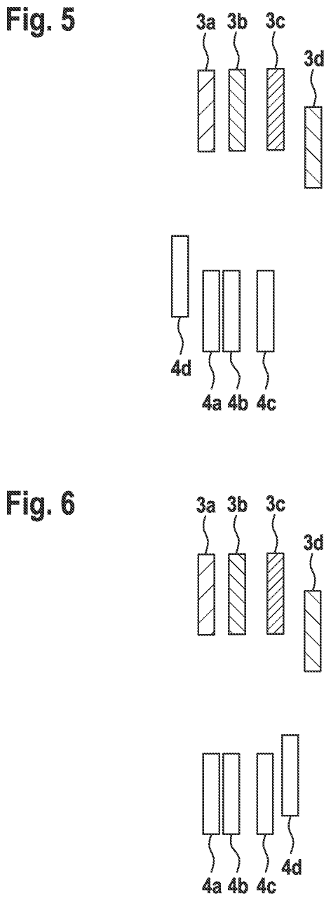

FIG. 4 shows a top view of a radar device including three transmitting antennas 3a through 3c situated horizontally next to one another and three receiving antennas 4a through 4c situated vertically next to one another, which are situated vertically offset with respect to transmitting antennas 3a through 3c. Evaluation unit 5, for example, an MMIC (Monolithic Microwave Integrated Circuit), is situated in the center. First transmitting antenna 3a may exhibit a horizontal overlap with first receiving antenna 4a in the horizontal extension. The same applies for second transmitting antenna 3b with second receiving antenna 4a and for third transmitting antenna 3c with third receiving antenna 4c.

FIG. 5 shows a top view of a further radar device. This radar device also includes a further fourth transmitting antenna 3d, which is vertically offset with respect to first through third transmitting antennas 3a through 3c, as well as a further fourth receiving antenna 4d, which is vertically offset with respect to first through third receiving antennas 4a through 4c. Fourth transmitting antenna 4d in this case is situated to the right next to first through third transmitting antennas 3a through 3c and fourth receiving antenna 4d is situated to the left next to first through third receiving antennas 4a through 4c. Evaluation unit 5 in this case may be located on a rear side of a circuit board, transmitting antennas 3a through 3d and receiving antennas 4a through 4d being situated on the upper side of the circuit board.

FIG. 6 shows a top view of a further radar device. This radar device differs from the radar device shown in FIG. 5 in that fourth transmitting antenna 4d is situated to the right next to first through third transmitting antennas 3a through 3c, and fourth receiving antenna 4d is situated to the right next to first through third receiving antennas 4a through 4c.

According to one further specific embodiment, only at least one transmitting antenna 4a through 4d is vertically offset, whereas receiving antennas 3a through 3d are situated in the same vertical position (MISO principle).

According to one further specific embodiment, only at least one receiving antenna 3a through 3d is vertically offset, whereas transmitting antennas 4a through 4d are situated in the same vertical position (SIMO principle).

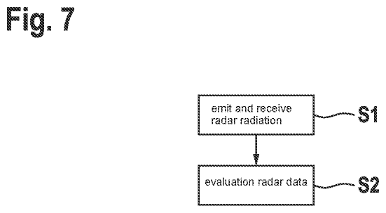

FIG. 7 shows a flowchart of a radar method.

In a first step S1, radar radiation is emitted and received again with the aid of a transceiver unit 2 that includes at least three transmitting antennas 2 and at least three receiving antennas 3, and radar data are generated based on the received radar radiation.

In a second step S2, the radar data are evaluated using a 2-target angle estimation model in order to estimate at least one angle of at least one target, the 2-target angle estimation model taking the propagation of radar radiation along fourth paths into account. The at least one angle of the at least one target may be estimated using a maximum likelihood estimation.

What is claimed is:

1. A radar device, comprising:
a transceiver unit that includes at least three transmitting antennas and at least three receiving antennas, the transceiver unit being configured to emit radar radiation using the transmitting antennas, to receive radar radiation using the receiving antennas and to generate radar data based on the received radar radiation; and
an evaluation unit configured to estimate, by evaluating the radar data, at least one angle of at least one target using a 2-target angle estimation model, the 2-target angle estimation model taking propagation of radar radiation along four paths into account.

2. The radar device as recited in claim 1, wherein the four paths include a direct path, a reflection path and two cross paths, each of the four paths including a first path section from the transmitting antennas to the target and a second path section from the target to the receiving antennas, in the case of the direct path, the propagation of the radar radiation on the first path section and on the second path section taking place directly in each case, in the case of the reflection path, the propagation of the radar radiation on the first path section and on the second path section taking place via a reflection in each case, in the case of a first of the cross paths, the propagation of the radar radiation on the first path section taking place directly and on the second path section taking place via a reflection, and in the case of a second of the cross paths, the propagation of the radar radiation on the second path section taking place directly and on the second path section taking place via a reflection.

3. The radar device as recited in claim 1, wherein the transmitting antennas and the receiving antennas are situated in areas spatially separated from one another.

4. The radar device as recited in claim 3, wherein the evaluation unit is situated between the transmitting antennas and the receiving antennas.

5. The radar device as recited in claim 1, wherein the at least three transmitting antennas are situated horizontally next to one another, the at least three receiving antennas are situated horizontally next to one another, at least one further transmitting antenna being situated vertically offset to the at least three transmitting antennas, and/or at least one further receiving antenna being situated vertically offset to the at least three receiving antennas, and the evaluation unit being configured to estimate an elevation angle and an azimuth angle of the at least one target.

6. The radar device as recited in claim 5, wherein: (i) all transmitting antennas are situated horizontally next to one another and the at least one further receiving antenna is situated vertically offset to the at least three receiving antennas situated horizontally next to one another, or (ii) all receiving antennas are situated horizontally next to one another and the at least one further transmitting antenna is situated vertically offset to the at least three transmitting antennas situated horizontally next to one another.

7. The radar device as recited in claim 1, wherein at least one of the transmitting antennas exhibits a horizontal overlap with at least one of the receiving antennas.

8. The radar device as recited in claim 1, wherein the evaluation unit is configured to estimate the at least one angle of the at least one target using a maximum likelihood estimation.

9. The radar device as recited in claim 1, wherein the evaluation unit is configured to estimate an elevation angle using a MIMO method using fewer than three of the transmitting antennas and fewer than three of the receiving antennas.

10. The radar device as recited in claim 1, wherein the evaluation unit is configured initially to estimate at least one first angle estimated value of the at least one target using a first angle grid, and subsequently to estimate a second angle estimated value of the at least one target by the at least one first angle estimated value using a second angle grid, the second angle grid being finer than the first angle grid.

11. A radar method, comprising the following steps:
emitting and receiving radar radiation with the aid of a transceiver unit that includes at least three transmitting antennas and at least three receiving antennas, and generating radar data based on the received radar radiation; and
evaluating the radar data using a 2-target angle estimation model to estimate at least one angle of at least one target, the 2-target angle estimation model taking propagation of radar radiation along four paths into account.

12. The radar method as recited in claim 11, wherein the at least one angle of the at least one target is estimated using a maximum likelihood estimation.
